(19) United States
(12) Patent Application Publication
(10) Pub. No.: US 2024/0051397 A1
(43) Pub. Date: Feb. 15, 2024

(54) METHOD FOR DISCHARGING AT LEAST ONE ELECTRICAL ENERGY STORAGE UNIT OF A CIRCUIT

(71) Applicant: VALEO EQUIPEMENTS ELECTRIQUES MOTEUR, Creteil Cedex (FR)

(72) Inventors: Joachim LAUPA, Creteil Cedex (FR); Hicham LAHBIL, Creteil Cedex (FR)

(73) Assignee: VALEO EQUIPEMENTS ELECTRIQUES MOTEUR, Creteil Cedex (FR)

(21) Appl. No.: 18/264,796

(22) PCT Filed: Jan. 28, 2022
(86) PCT No.: PCT/EP2022/051986

§ 371 Date: Aug. 9, 2023

(30) Foreign Application Priority Data
Feb. 11, 2021 (FR) FR2101330

(51) Int. Cl. B60L 3/04; H02P 27/06

(52) U.S. Cl. CPC B60L 3/04; H02P 27/06; B60L 2210/42; B60L 2220/56

(57) ABSTRACT

A method for discharging an electrical energy storage unit of an electrical circuit includes a first switching system defining a DC/AC voltage converter and interposed between a first electrical sub-circuit, which includes the electrical energy storage unit and the electrical winding of the stator of a rotary electric machine. A second switching system defines a DC/DC voltage converter interposed between the first electrical sub-circuit and a second electrical sub-circuit. At least one electrical consumer forms part of the first electrical sub-circuit. The method includes detecting that the voltage across the terminals of the electrical energy storage unit exceeds a predefined threshold, and controlling at least one of the first switching system, the second switching system and the electrical consumer so as to reduce the voltage across the terminals of the electrical energy storage unit by circulating an additional current in the stator electrical winding, second switching system, or electrical consumer.

The present invention relates to discharging at least one electrical energy storage unit of an electrical circuit of a vehicle, for example, an automobile. This electrical energy storage unit is, for example, a capacitor or a set of capacitors. The electrical circuit further comprises:
a first switching system defining a DC/AC voltage converter and interposed between a first electrical sub-circuit, which includes the electrical energy storage unit and the electrical winding of the stator of a rotary electric machine;
a second switching system defining a DC/DC voltage converter interposed between the first electrical sub-circuit and a second electrical sub-circuit; and
at least one electrical consumer forming part of the first electrical sub-circuit.

The first electrical sub-circuit has, for example, a nominal voltage of 48 V and the second electrical sub-circuit has, for example, a nominal voltage of 12 V.

This electrical energy storage unit is arranged parallel to the direct input of the first switching system, and this energy storage unit may need to be discharged in order to prevent the voltage across its terminals from remaining above a predefined value. This predefined value may be related to safety requirements, for example, during load shedding and/or may be related to a desire to not prematurely wear this electrical energy storage unit when the vehicle is stopped by maintaining an excessive voltage at its terminals.

It is known for such an electrical energy storage unit to be discharged via the DC/AC voltage converter by providing a “rotating” short circuit on the arms of this converter, for example, this is known from patent EP 3053236. When the rotary electric machine has an excitation winding on the rotor, it is also known for the chopper controlling this excitation winding to be acted upon in order to carry out this discharging.

The aim of the invention is to allow such an electrical energy storage unit to be discharged, whether or not the rotor has an excitation winding on the rotor, and it achieves this aim, according to one of the aspects thereof, using a method for discharging at least one electrical energy storage unit of an electrical circuit, notably a capacitor or a battery, the electrical circuit further comprising:
a first switching system defining a DC/AC voltage converter and interposed between a first electrical sub-circuit, which includes the electrical energy storage unit and the electrical winding of the stator of a rotary electric machine;
a second switching system defining a DC/DC voltage converter interposed between the first electrical sub-circuit and a second electrical sub-circuit; and
at least one electrical consumer forming part of the first electrical sub-circuit,
   which method comprises:
detecting that the voltage across the terminals of the electrical energy storage unit exceeds a predefined threshold value; and
controlling at least one from among the first switching system, the second switching system and the electrical consumer so as to reduce the voltage across the terminals of the electrical energy storage unit by circulating an additional current in the stator electrical winding, or in the second switching system, or in the electrical consumer.

The circulation of this additional current allows the value of the voltage across the terminals of the electrical energy storage unit to be reduced.

The first electrical sub-circuit may have a nominal voltage of 48 V and the second electrical sub-circuit may have a nominal voltage of 12 V.

As an alternative embodiment, the first electrical sub-circuit may have a nominal voltage greater than 300 V.

The stator electrical winding defines a dual three-phase system and the reduction of the voltage across the terminals of the electrical energy storage unit may be achieved by circulating a first additional current in a first three-phase system and a second additional current in a second three-phase system. As an alternative embodiment, when a dual three-phase system is defined, the additional current may only circulate in the first three-phase system or in the second three-phase system.

The electrical stator winding is formed, for example, by electrical wires or by conductive bars connected to one another.

The rotor of the rotary electric machine is devoid, for example, of an electrical excitation winding.

This rotor supports a plurality of permanent magnets, for example.

The rotary electric machine is a synchronous machine, for example. As an alternative embodiment, it may be an asynchronous machine.

According to a first embodiment of the invention, the first switching system is controlled so as to decrease the voltage across the terminals of the electrical energy storage unit by circulating an additional current in the stator electrical winding so that the first motor torque generated by the electric machine is less than a predefined value. The motor torque is less than 5 Nm, for example. This control of the switching system implements, for example, a vector control using a Clarke or Concordia matrix, for example.

This vector control may implement a direct component for the current that generates a flux, and not torque.

According to a second embodiment, which may be alternative or in addition to the first embodiment, the second switching system is controlled so that it supplies the second sub-circuit from the first subcircuit. This supply of the second sub-circuit corresponds to the circulation of the additional current.

The circulation of the additional current according to this second embodiment allows the discharged energy to be used in the second sub-circuit, for example, to recharge a battery of the second sub-circuit.

According to this second embodiment, controlling the second switching system for circulating the additional current may only occur for voltage values across the terminals of the electrical energy storage unit below a given value, this given value may or may not be greater than the aforementioned predefined threshold value. This given value corresponds to the voltage value below which the second switching system is on. This given value may range between 55 V and 65 V, notably ranging between 57 V and 63 V. When the second switching system is a DC/DC voltage converter, then when the voltage across the terminals of the electrical energy storage unit crosses the given value, this may correspond to this DC/DC voltage converter being safeguarded.

According to a third embodiment, which may be an alternative embodiment to the first and to the second embodiment, or may be added to either one of the embodiments described above, the electrical consumer is controlled so that the additional current circulates in this consumer. The electrical consumer is, for example, an electric supercharger compressor. In the latter case, the electric supercharger compressor is, for example, subjected to a low torque due to this circulation of current, with the value of this torque not being able to rotate the rotary part of this electric compressor.

The electrical energy storage unit is formed, for example, by one or more capacitors, with the capacitance of this electrical energy storage unit notably ranging between 2,000 μF and 4,000 μF, for example, of the order of 3,000 μF.

Throughout the above, the first sub-circuit may comprise a battery distinct from the electrical energy storage unit, and the method may comprise the prior step of checking that this battery is properly disconnected from the first sub-circuit.

Throughout the above, at least one from among the first switching system, the second switching system, and the electrical consumer may be controlled so as to decrease the voltage across the terminals of the electrical energy storage unit by circulating an additional current in the stator electrical winding, or in the second switching system, or in the electrical consumer until this voltage across the terminals of the electrical energy storage unit reaches another predefined threshold value. This other threshold value may be greater than or equal to 0 V, ranging between 24 V and 52 V, for example.

Throughout the above, the duration elapsing between detecting that the voltage across the terminals of the electrical energy storage unit has exceeded the predefined threshold value and the end of controlling the first switching system and/or the second switching system and/or the electrical consumer, so as to reduce the voltage across the terminals of the electrical energy storage unit by circulating an additional current, may be less than a given value, for example, 100 ms, for example, 40 ms.

Throughout the above, when the first electrical sub-circuit has a nominal voltage of 48 V, the predefined threshold value, the detection of which causes the circulation of the additional current, may range between 50 V and 60 V, being equal to 60 V, for example. If applicable, the circulation of the additional current also may be dependent upon detecting whether this threshold value has been exceeded for a predefined duration. This involves, for example, a duration of 40 ms for a threshold value of 60 V.

A further aim of the invention is, according to another aspect thereof, an electrical circuit intended to be placed on board a vehicle, comprising:
a first electrical sub-circuit comprising an electrical energy storage unit and at least one electrical consumer;
a first switching system defining a DC/AC voltage converter and interposed between the first electrical sub-circuit and the electrical winding of the stator of a rotary electric machine;
a second electrical sub-circuit;
a second switching system defining a DC/DC voltage converter interposed between the first electrical sub-circuit and the second electrical sub-circuit; and
a control unit configured to implement the method as defined above.

The control unit may be integrated into the central computer of the vehicle (VCU). As an alternative embodiment, the control unit may be dedicated to the powertrain of the vehicle.

Throughout the above, the stator may be housed in a casing, with this casing forming an enclosure containing oil, with this oil circulating in this enclosure so as to cool the electrical winding of the stator and then coming into contact with the rotor. As an alternative embodiment, the oil can circulate in the shaft integral with the rotor, and this oil is radially sprayed into the machine via one or more openings provided in the wall of this shaft.

As a further alternative embodiment, the electric machine may be cooled by water or by air.

A further aim of the invention, according to another aspect thereof, is a transmission system for an electric or hybrid propulsion vehicle, comprising:
an electric machine as defined above; and
a gearbox, comprising pinions, defining gearbox ratios.

The shaft of the rotary electric machine is, for example, rotationally integral with an input shaft of the gearbox, or with the output shaft of the gearbox or with idler gears. If applicable, a reduction gear is interposed between the shaft of the rotary electric machine and the input shaft of the gearbox, or between the shaft of the rotary electric machine and the output shaft of the gearbox.

The shaft of the rotary electric machine is, for example, rotationally integral with the front axle or with the rear axle of the transmission system.

The propulsion system comprises, for example, a dry or wet dual clutch, with each of the output shafts of the dual clutch then forming an input shaft for the gearbox. In this case, the shaft of the rotary electric machine is, for example, rotationally integral with either one of these two input shafts of the gearbox.

The rotary electric machine may have a nominal electric power in motor mode of 4 kW, 8 kW, 15 kW, 25 kW or more.

At least one of the switching systems, notably each switching system, may implement controllable electronic switches, such as transistors made of gallium nitride (GaN), silicon carbide (SiC), or silicon. All or part of the above description with respect to the electronic component is still applicable to this other aspect of the invention.

The invention may be better understood upon reading the following description of non-limiting examples thereof and with reference to the appended drawings, in which:

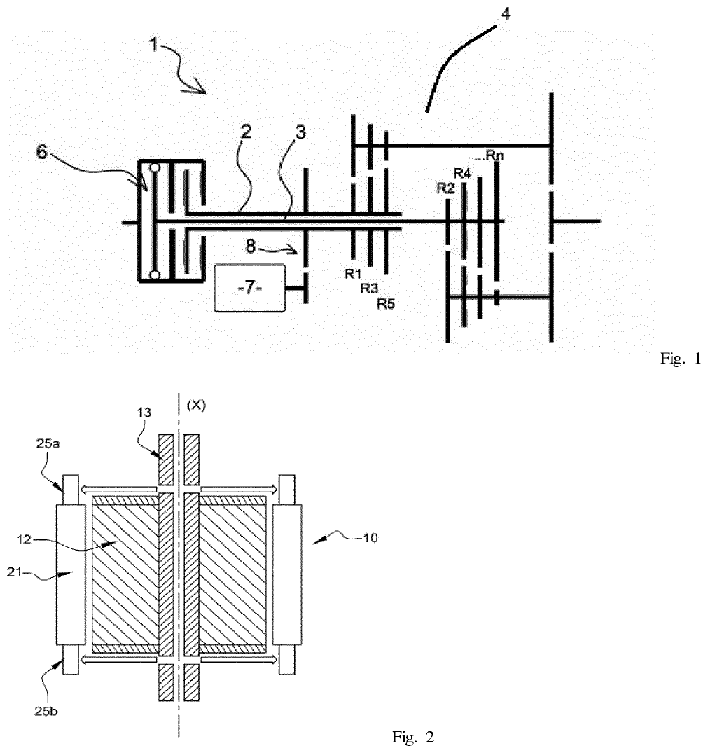

FIG. 1 schematically and partially shows a transmission system to which an embodiment of the invention may be applied;

FIG. 2 schematically shows an example of a rotary electric machine of the system of FIG. 1, immersed in oil;

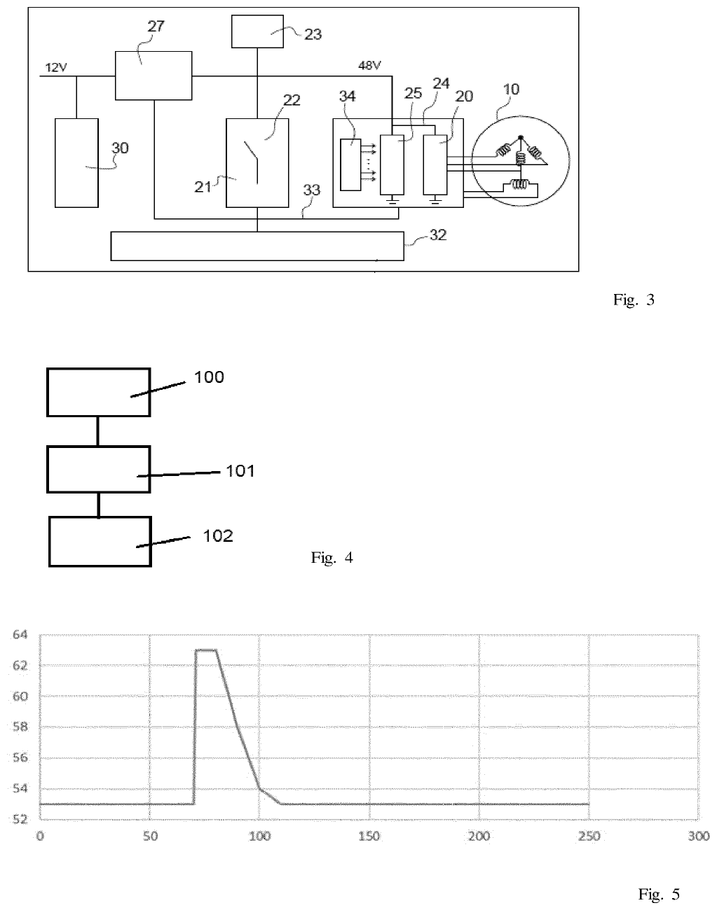

FIG. 3 schematically shows the electrical circuit of the rotary electric machine of the transmission system of FIGS. 1 and 2;

FIG. 4 shows a diagram of the various steps of a method according to one embodiment of the invention; and

FIG. 5 is a curve showing the evolution of the voltage across the terminals of the electrical energy storage unit when an embodiment of the method is applied.

FIG. 1 shows a transmission system 1 to which the invention may be applied. The transmission system 1 in this case comprises a dual clutch 6 that may be dry or wet, with disks or lamella.

This dual clutch has two output shafts 2 and 3, which in this case are concentric. Each of these shafts defines an input shaft of a gearbox 4. The gearbox 4 comprises, inside a casing filled with oil, a plurality of pinions defining a plurality of gear ratios R1-Rn. The shaft 2 in this case is associated with odd gear ratios and the shaft 3 is associated with even gear ratios.

The output torque of the gearbox 4 is transferred to the wheels of the vehicle, in order to propel this vehicle.

The transmission system 1 is hybrid or electric, comprising a rotary electric machine 7. This rotary machine 7 is installed inside the casing of the gearbox 4. In the considered example, the shaft of the rotary machine 7 is able to engage by meshing with a pinion 8 integral with the input shaft 2 of the gearbox associated with the odd gear ratios, but other positions are possible for the rotary electric machine 7, for example, it may mesh with a pinion integral with the input shaft 3 of the gearbox associated with the even gear ratios.

This rotary electric machine 7 may form an alternator-starter of the vehicle. The rotary electric machine 7 comprises a casing, not shown in FIG. 2. Inside this casing, it further comprises a shaft 13, a rotor 12 rotationally integral with the shaft 13, and a stator 10 surrounding the rotor 12. The rotational movement of the rotor 12 occurs about an axis X.

Although not shown, the casing may comprise a front bearing and a rear bearing, which are assembled together and may each have a hollow shape and centrally support a respective ball bearing for rotatably mounting the shaft 13.

In this embodiment, the stator 10 comprises a body 21 in the form of a pack of laminations provided with notches, for example, of the semi-closed or open type, fitted with insulation for the notches for mounting the polyphase electrical winding of the stator. Each phase comprises a winding passing through the notches of the body 21 and forming, with all the phases, a front winding 25a and a rear winding 25b on either side of the body of the stator. The windings are acquired, for example, from a continuous wire covered with enamel or from conductive elements in the form of a bar, such as pins connected to each other. The electrical winding of the stator is three-phase, for example, then implementing a star or delta mounting, the outputs of which are connected to the electronic power component 9. As an alternative embodiment, the electrical winding of the stator may define a dual three-phase system.

The rotor 12 of FIG. 2 is formed by a stack of laminations, as shown in FIG. 2. There may be any number of pairs of poles defined by the rotor 12, for example, ranging between three and eight, being equal to six or eight, for example.

FIG. 2 also shows that the shaft 13 is hollow, with oil circulating through said shaft. Openings, provided in the shaft 13 and shown in FIG. 2, allow oil to be radially sprayed into the machine, so that the rotor and the stator are immersed in oil, in the considered example.

The machine also comprises sensors for measuring the position of the rotor, not shown in FIG. 2. These sensors are, for example, three Hall-effect sensors interacting with a magnetic target rotationally integral with the rotor, but other sensors are possible, such as resolvers.

The electrical winding of the stator of the rotary electric machine 7 forms part of an electrical circuit comprising a first switching system 20 defining an inverter/rectifier. This first switching system 20 is interposed between the electrical winding of the stator and a first electrical sub-circuit, the nominal voltage of which is equal to 48 V in the described example. The first switching system 20 comprises several switching arms, for example, with each arm implementing two transistors mounted in series and separated by a midpoint. Each transistor is a transistor made of gallium nitride (GaN), silicon carbide (SiC), or silicon, for example.

The first sub-circuit also comprises, in the example described, a battery 21 connected to the rest of this first electrical sub-circuit by a disconnection switch 22. The first sub-circuit further comprises a plurality of consumers 23, including, for example, an electric supercharger compressor.

An electrical energy storage unit 25 is arranged on the terminals of the direct input 24 of the first switching system 20, which is formed, for example, by a capacitor or by assembling several capacitors.

This electrical energy storage unit 25 has, for example, a capacitance ranging between 3,000 μF and 4,000 μF.

The electrical circuit also comprises, in the considered example, a second switching system 27 defining a DC/DC voltage converter interposed between the first electrical sub-circuit and a second electrical subcircuit. Like the first switching system 20, the second switching system 27 comprises transistors, for example, which may be the same type as those mentioned above. The second electrical sub-circuit has a nominal voltage of 12 V, for example.

In a known manner, this second electrical sub-circuit comprises a battery 30, as well as consumers (not shown), which may be selected from the following non-limiting list: lighting system, electric power assisted steering system, braking system, air conditioning system or car-radio system.

The electrical circuit further comprises a control unit 32, which may be the central computer of the vehicle or may be dedicated to all or part of the transmission system 1. This control unit 32 communicates via a data network 33, which is of the CAN type, for example, with various components of the electrical circuit, as may be seen in FIG. 3.

FIG. 4 shows various steps of a non-limiting example of a method.

During a step 100, the control unit receives the information indicating that the value of the voltage across the terminals of the electrical energy storage unit 25 exceeds a threshold value, for example, ranging between 50 V and 60 V.

During a step 101, the control unit implements one or more solutions allowing an additional current to circulate in the circuit in order to reduce this value of the voltage across the terminals of the electrical energy storage unit 25. If applicable, step 101 may be triggered only when the control unit 32 has checked that the disconnection switch 22 is open.

A first solution may involve controlling the first switching system 20 so as to circulate an additional current in the stator electrical winding. This control may involve a vector control in accordance with a direct component and a quadrature component. The circulation of this current in the electrical stator winding results in the appearance of a motor torque. The control may cause this motor torque to be less than a predefined value. As mentioned above, when the electrical winding of the stator defines a dual three-phase system, the additional current may be distributed between these two systems.

The evolution of the voltage across the terminals of the energy storage unit 25 when the first solution is implemented corresponds to the depiction in FIG. 5, for example.

A second solution, which may be added to the first solution, or may be used alternatively, involves, during step 101, controlling the second switching system 25 so that the additional current circulates through said second switching system in order to supply the second electrical sub-circuit from the pre-electrical sub-circuit. This second solution may be triggered only for voltage values across the terminals of the electrical energy storage unit 25 that are below a given value, for which the DC/DC voltage converter 27 is on. This given value may range between 55 V and 65 V, notably between 57 V and 63 V.

A third solution, which may be added to the first and/or the second solution, or may be used alternatively to these previous solutions, involves, during step 101, controlling the electrical consumer 23, which in this case is an electric supercharger compressor, so that said compressor consumes the additional current. This control also does not cause the rotation of the rotary part of the electric supercharger compressor or may cause a rotation of this rotary part at a certain speed, for example, at 5,000 rpm.

During an optional step 102, a check is undertaken to determine that the voltage across the terminals of the electrical energy storage unit has reached another predefined threshold value.

The set of steps 100 to 102 may be carried out over a duration of less than 100 ms, notably of 40 ms.

The value of the duration during which step 101 is applied and the value of the additional current circulating during this step 101 may vary as a function of data such as:
the value of the voltage across the terminals of the electrical energy storage unit when this step 101 is triggered (or, alternatively, the threshold value from which the excess is referenced); and
the value of this same voltage that is intended to be maintained on completion of discharging.

Various examples of discharging are shown in the table below, with these various examples being able to be acquired via any one of the solutions described above:

TABLE 1

| 70 V → 48 V | | 65 V → 48 | | 60 V → 48 | | 52 V → 5 V | |
|---|---|---|---|---|---|---|---|
| T = 10 ms | 8.8 A | T = 10 ms | 6.8 A | T = 10 ms | 4.8 A | T = 10 ms | 18.8 A |
| T = 20 ms | 4.4 A | T = 20 ms | 3.4 A | T = 20 ms | 2.4 A | T = 20 ms | 9.4 A |
| T = 40 ms | 2.2 A | T = 40 ms | 1.7 A | T = 40 ms | 1.2 A | T = 40 ms | 4.7 A |
| T = 100 ms | 0.88 A | T = 100 ms | 0.68 A | T = 100 ms | 0.48 A | T = 100 ms | 1.88 A |
| T = 200 ms | 0.44 A | T = 200 ms | 0.34 A | T = 200 ms | 0.24 A | T = 200 ms | 0.94 A |
| T = 500 ms | 0.176 A | T = 500 ms | 0.136 A | T = 500 ms | 0.096 A | T = 500 ms | 0.376A |
| T = 1 s | 0.088 A | T = 1 s | 0.068 A | T = 1 s | 0.048 A | T = 1 s | 0.188 A |
| T = 2 s | 0.044 A | T = 2 s | 0.034 A | T = 2 s | 0.024 A | T = 2 s | 0.094 A |

The invention is not limited to the examples that have been described above.

The invention alternatively also may be implemented when the electrical circuit is connected to a recharging terminal, by discharging the electrical energy storage unit by circulating an additional current in this recharging terminal, as an alternative or in addition to circulating an additional current in the stator electrical winding, or in the second switching system, or in the electrical consumer.

1. A method for discharging at least one electrical energy storage unit of an
electrical circuit, notably a capacitor or a battery, the electrical circuit further comprising:
a first switching system defining a DC/AC voltage converter and interposed between a first electrical sub-circuit, which includes the electrical energy storage unit and the electrical winding of the stator of a rotary electric machine;
a second switching system defining a DC/DC voltage converter interposed between the first electrical sub-circuit and a second electrical sub-circuit; and
at least one electrical consumer forming part of the first electrical subcircuit,
which method comprises:
detecting that the voltage across the terminals of the electrical energy storage unit exceeds a predefined threshold value; and
controlling at least one from among the first switching system, the second switching system and the electrical consumer so as to reduce the voltage across the terminals of the electrical energy storage unit by circulating an additional current in the second switching system, or in the electrical consumer.

2. The discharging method as claimed in claim 1, wherein the first electrical sub-circuit
has a nominal voltage of 48 V and wherein the second electrical sub-circuit has a nominal voltage of 12 V.

3. The method as claimed in claim 1, wherein the stator electrical winding
defines a dual three-phase system and wherein the voltage across the terminals of the electrical energy storage unit is decreased by circulating a first additional current in a first three-phase system and a second additional current in a second three-phase system.

4. The method as claimed in claim 1, wherein the
first switching system is controlled so as to decrease the voltage across the terminals of the electrical energy storage unit by circulating an additional current in the stator electrical winding so that the first motor torque generated by the electric machine is less than a predefined value.

5. The method as claimed in claim 1, wherein the
second switching system is controlled so that it supplies the second sub-circuit from the first sub-circuit.

6. The method as claimed in claim 1, wherein the
electrical consumer is controlled so that the additional current circulates in this consumer.

7. The method as claimed in claim 1, wherein the electrical energy storage unit
is formed by one or more capacitors, with the capacitance of this electrical energy storage unit notably ranging between 2,000 μF and 4,000 μF.

8. The method as claimed in claim 7, with the first sub-circuit comprising a battery
distinct from the one or more capacitors, and the method comprising the prior step of checking that this battery is properly disconnected from the first sub-circuit.

9. The method as claimed in claim 1, wherein the
at least one from among the first switching system, the second switching system, and the electrical consumer is controlled so as to decrease the voltage across the terminals of the electrical energy storage unit by circulating an additional current in the stator electrical winding, or in the second switching system, or in the electrical consumer until this voltage across the terminals of the electrical energy storage unit reaches another predefined threshold value.

10. An electrical circuit intended to be placed on board a vehicle, comprising:
a first electrical sub-circuit comprising an electrical energy storage unit and at least one electrical consumer;
a first switching system defining a DC/AC voltage converter and interposed between the first electrical sub-circuit and the electrical winding of the stator of a rotary electric machine;
a second electrical sub-circuit;
a second switching system defining a DC/DC voltage converter interposed between the first electrical sub-circuit and the second electrical sub-circuit; and
a control unit configured to implement the method as claimed in claim 1.

11. The method as claimed in claim 2, wherein the stator electrical winding
defines a dual three-phase system and wherein the voltage across the terminals of the electrical energy storage unit is decreased by circulating a first additional current in a first three-phase system and a second additional current in a second three-phase system.

12. The method as claimed in claim 2, wherein the
first switching system is controlled so as to decrease the voltage across the terminals of the electrical energy storage unit by circulating an additional current in the stator electrical winding so that the first motor torque generated by the electric machine is less than a predefined value.

13. The method as claimed in claim 2, wherein the
second switching system is controlled so that it supplies the second sub-circuit from the first sub-circuit.

14. The method as claimed in claim 2, wherein the
electrical consumer is controlled so that the additional current circulates in this consumer.

15. The method as claimed in claim 2, wherein the electrical energy storage unit
is formed by one or more capacitors, with the capacitance of this electrical energy storage unit notably ranging between 2,000 μF and 4,000 μF.

16. The method as claimed in claim 2, wherein the
at least one from among the first switching system, the second switching system, and the electrical consumer is controlled so as to decrease the voltage across the terminals of the electrical energy storage unit by circulating an additional current in the stator electrical winding, or in the second switching system, or in the electrical consumer until this voltage across the terminals of the electrical energy storage unit reaches another predefined threshold value.

17. An electrical circuit intended to be placed on board a vehicle, comprising:
a first electrical sub-circuit comprising an electrical energy storage unit and at least one electrical consumer;
a first switching system defining a DC/AC voltage converter and interposed between the first electrical sub-circuit and the electrical winding of the stator of a rotary electric machine;
a second electrical sub-circuit;
a second switching system defining a DC/DC voltage converter interposed between the first electrical sub-circuit and the second electrical sub-circuit; and
a control unit configured to implement the method as claimed in claim 2.

18. The method as claimed in claim 3, wherein the
first switching system is controlled so as to decrease the voltage across the terminals of the electrical energy storage unit by circulating an additional current in the stator electrical winding so that the first motor torque generated by the electric machine is less than a predefined value.

19. The method as claimed in claim 3, wherein the
second switching system is controlled so that it supplies the second sub-circuit from the first sub-circuit.

20. The method as claimed in claim 3, wherein the
electrical consumer is controlled so that the additional current circulates in this consumer.
